(19) United States
(12) Patent Application Publication
(10) Pub. No.: US 2016/0009215 A1
(43) Pub. Date: Jan. 14, 2016

(54) TIE-DOWN/SLING APPARATUSES AND ASSOCIATED METHODS

(71) Applicants: Michael Wu, Brea, CA (US); Paul Lee, Cerritos, CA (US)

(72) Inventors: Michael Wu, Brea, CA (US); Paul Lee, Cerritos, CA (US)

(21) Appl. No.: 14/327,374

(22) Filed: Jul. 9, 2014

(51) Int. Cl. B60P 7/08; B32B 37/12; B32B 37/26; B32B 38/00; B32B 38/10; B32B 37/24; B32B 37/06

(52) U.S. Cl. CPC B60P 7/0823; B32B 37/24; B32B 37/12; B32B 37/06; B32B 38/145; B32B 38/10; B32B 37/26; B32B 2037/243; B32B 2553/00

(57) ABSTRACT

Embodiments of tie-down apparatuses and associated methods are disclosed herein. An exemplary tie-down/sling apparatus can include a first flat component having a first surface and a second flat component having a first side and a second side opposite the first side. The second flat component can be positioned on the first flat component by fixedly attaching the first side to the first surface. The second side of the second flat component can include a reflective surface configured to visually present a set of information to an operator or others.

### TECHNICAL FIELD

Various embodiments of the present technology generally relate to tie-down/sling apparatuses and associated methods. More specifically, some embodiments of the present technology relate to improved tie-down/sling apparatuses with reflective indicators.

### BACKGROUND

Tie-down/sling apparatuses are often used to secure loads to carriers (or hanging loads to a certain place), so as to prevent shifting during transportation. Tasks of fastening or securing loads to carriers are often time-sensitive and need to be done at specific areas (e.g., a place with insufficient lighting) within limited time periods. Therefore, it can be very difficult or inconvenient for operators to properly operate these tie-down/sling apparatuses under these circumstances.

Improperly-operated tie-down/sling apparatuses may result in serious safety issues as well as significant economic losses. Therefore, an improved tie-down/sling apparatus that can provide instructions or certain information to operations under these circumstances is desirable and advantageous.

### BRIEF DESCRIPTION OF THE DRAWINGS

FIG. 1 is a schematic view of a tie-down/sling apparatus in accordance with various embodiments of the present technology.

FIG. 2 is a side view of a tie-down/sling apparatus in accordance with various embodiments of the present technology.

FIG. 3 is a top view of a tie-down/sling apparatus in accordance with various embodiments of the present technology.

FIG. 4 is a top view of a tie-down/sling apparatus in accordance with various embodiments of the present technology.

FIG. 5 is a side view of a tie-down/sling apparatus in accordance with various embodiments of the present technology.

FIG. 6 is a flow chart illustrating a method in accordance with various embodiments of the present technology.

### DETAILED DESCRIPTION

Various embodiments of the present technology generally relate to tie-down/sling apparatuses and associated methods. More specifically, some embodiments of the present technology relate to a tie-down/sling apparatus with a reflective/indicative surface and methods for manufacturing the same. An exemplary tie-down/sling apparatus can include a first flat component (e.g., a body of the tie-down apparatus) and a second flat component (e.g., a reflective indicator or a reflective layer) coupled to (or positioned on) the first flat component. The first flat component can include a first surface configured to be in contact with a first side of the second flat component. The second flat component can include a second side opposite the first side. The second side of the second flat component can include a reflective surface that is configured to visually present a set of information to an operator (e.g., one who operates the tie-down/sling apparatus) or others.

In various embodiments, the first flat component and the second flat component can be coupled by fixedly attaching the first side (of the second flat component) to the first surface (of the first flat component). The first flat component and the second flat component can be coupled by adhesives, heat press processes, silk screen printing processes and/or other suitable means.

In various embodiments, a tie-down/sling apparatus can include a microelectronic device positioned between the first flat component and the second component. The microelectronic device can store, receive, and/or transmit suitable signals and/or information (e.g., a product identification of a load that is secured by the tie-down/sling apparatus) to an operator or others.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The phrases “in some embodiments,” “in various embodiments,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments. If the specification states a component or feature “may” or “can” be included or have a characteristic, that particular component or feature is not required to be included or have the characteristic.

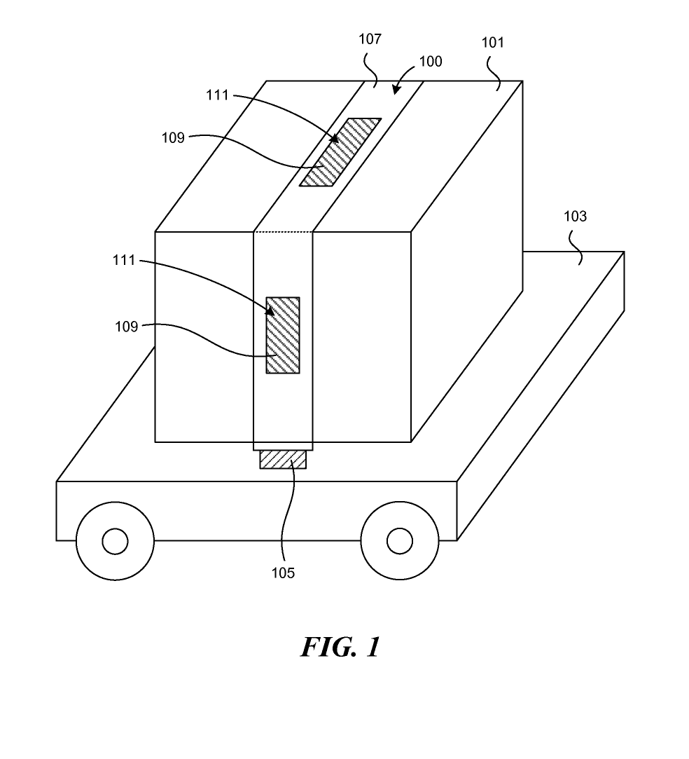

FIG. 1 is a schematic view of a tie-down/sling apparatus 100 in accordance with various embodiments of the present technology. The exemplary embodiment shown in FIG. 1 illustrates how the tie-down/sling apparatus 100 can secure a load 101 (e.g., a packaged box, a container, and/or the like) on a carrier 103 (e.g., a trailer, a truck, other suitable vehicles, or the like). The tie-down/sling apparatus 100 can include a locking component 105 (e.g., a ratchet device, a buckle device, a latch device, a connecting ring, a s-shaped hook, or the like). By connecting the locking component 105 with the carrier 103, the load 101 can be properly secured on the carrier 103. As shown in FIG. 1, the tie-down/sling apparatus 100 can include a first flat component 107 (e.g., a belt) and at least one second flat component 109 (e.g., a reflective imprint layer or indicator) positioned on the first flat component 107. The second flat component 109 can be fixedly attached to the first flat component 107. The second flat component 109 can have a reflective surface 111 that can visually convey suitable information to an operator or others. The reflective nature of the reflective surface 111 allows the tie-down/sling apparatus 100 to provide better visibility and clarity to an operator or others, especially when the tie-down/sling apparatus 100 are operated in places with insufficient lighting.

Examples of the suitable information can include instructions for properly operating the tie-down/sling apparatus 100, brand names, marketing materials (e.g., an advertisement), and/or other suitable information. For example, an instruction for properly operating the tie-down/sling apparatus 100 can be “THIS SIDE UP,” “DO NOT USE IF THE AMBIENT TEMPERATURE IS LOWER THAN 0° C.,” “SECURE BEFORE ENGINE STARTS,” etc. In some embodiments, the suitable information can be a brand name of a manufacturer of the tie-down/sling apparatus 100 (e.g., “BOXER TOOLS”). In some embodiment, the suitable information can be used to identify a shipping company or an owner of the load 101. In various embodiments, the suitable information can include marketing materials such as an advertisement, which can be seen by others during transportation of the load 101.

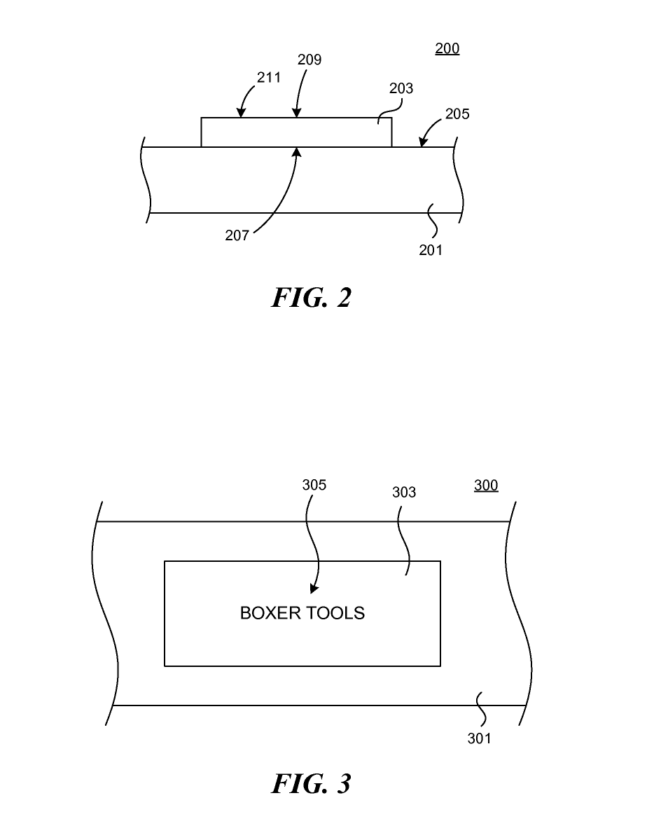

FIG. 2 is a side view of a tie-down/sling apparatus 200 in accordance with various embodiments of the present technology. In the illustrated embodiment, the tie-down/sling apparatus 200 includes a first flat component 201 and a second flat component 203. The first flat component 201 includes a first surface 205 configured to be in contact with the second flat component 203. In various embodiments, the first flat component 201 can be a belt or the like. In various embodiments, the first flat component 201 can be made of polyester, polypropylene, cotton, nylon, and/or other suitable materials. In various embodiments, the first flat component 201 can have a first thickness ranging from 1 mm to 5 mm. In some embodiments, a conditioning process can be performed on the first surface 205 before contacting it with the second flat component 203. For example, the conditioning process can include removing a protection layer (e.g., a plastic protection film) from the first surface 205. In other embodiments, the conditioning process can include removing impurities or undesired particles on the first surface 205.

In the illustrated embodiment, the second flat component 203 can include a first side 207 and a second side 209 opposite the first side 207. The second side 209 can further include a reflective surface 211 configured to visually present suitable information to an operator or users. In some embodiments, the reflective surface can include a fluorescent material. In various embodiments, the second flat component 203 can be an imprint layer, a pre-made layer, a thin film, and/or the like. In various embodiments, the second flat component 203 can be made of polyvinyl chloride (PVC), polyurethane (PU), and/or other suitable materials. In various embodiments, the second flat component 203 can have a second thickness ranging from 0.1 mm to 0.5 mm. In various embodiments, the second thickness can correspond to the first thickness. For example, a ratio of the second thickness to the first thickness can range from 0.02 (0.1/5) to 0.5 (0.5/1), depending on various factors such as materials of the first and second flat components.

As shown in FIG. 2, the first side 207 (of the second flat component 203) is fixedly attached with the first surface 205 (of the first flat component 201). In various embodiments, the first side 207 and the first surface 205 can be fixedly attached by a heat press process or other similar processes. In some embodiments, the operating temperature of the heat press process can range from 140° C. to 200° C. In some embodiments, the duration of the heat press process can be from 1 to 3 seconds. The operating pressure can vary depending on different materials of the first and second flat component 201 and 203. In other embodiments, the first side 207 and the first surface 205 can be fixedly attached by a silk screen printing process. During a silk screen printing process, at least a portion of the second flat component 203 can be formed from reflective ink positioned in a process tank. The reflective ink can then form the reflective surface 211. In other embodiments, the second flat component 203 can be pre-made by a molding process, and the first side 207 and the first surface 205 can be fixedly attached by suitable adhesives and/or a heat press process.

In various embodiments, the first flat component can be constituted of multiple plastic fibers, and the second flat component can be constituted by multiple reflective fibers. In these embodiments, the second flat component can be weaved or incorporated into the first flat component so as to form a tie-down/sling apparatus. In some embodiments, the first flat component and the second flat component can be fixedly attached by a sewing process.

FIG. 3 is a top view of a tie-down/sling apparatus 300 in accordance with various embodiments of the present technology. In the illustrative embodiment, the second flat component 303 is positioned on the first flat component 301. In the illustrated embodiment, the second flat component 303 is positioned at the center (e.g., along a width-direction) of the first flat component 301. In other embodiments, the second flat component 303 can be positioned at other place of the first flat component 301 (e.g., at one of the two ends, along a width-direction) depending on various designs. In the illustrated embodiment, suitable information configured to be conveyed to an operator or others can be positioned on a reflective surface 305. As shown in FIG. 3, a trade name “BOXER TOOLS” of the tie-down/sling apparatus 300 can be displayed on the reflective surface 305.

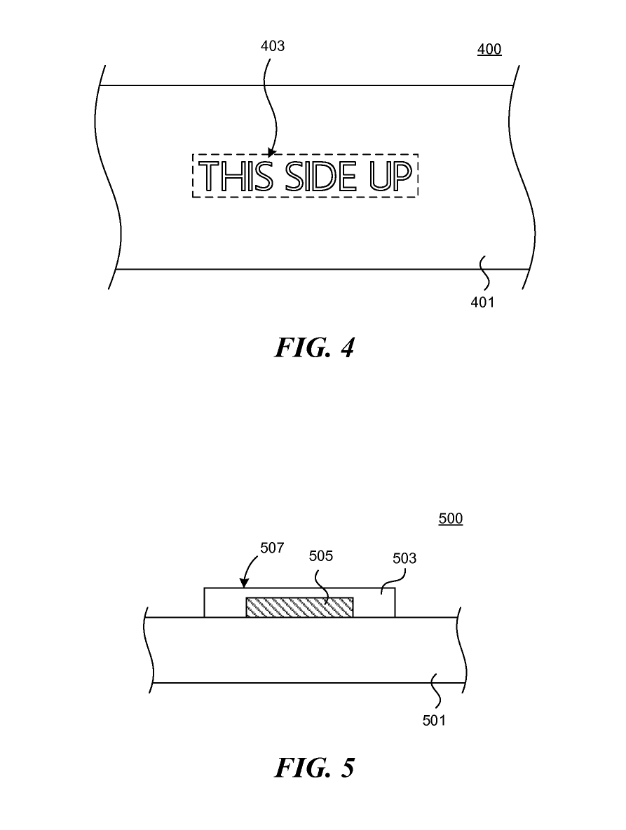

FIG. 4 is a top view of a tie-down/sling apparatus 400 in accordance with various embodiments of the present technology. In the illustrated embodiment, the tie-down/sling apparatus 400 can include a second flat component 403 positioned on a first flat component 401. In the illustrated embodiment, the second flat component 403 can be an imprint layer presented in a form of text.

FIG. 5 is a side view of a tie-down/sling apparatus 500 in accordance with various embodiments of the present technology. In the illustrated embodiment, the tie-down/sling apparatus 500 can include a first flat component 501, a second flat component 503 (at least partially) coupled to the first flat component 501, and a microelectronic device 505 positioned between the first flat component 501 and the second flat component 503. The first and second flat components 501 and 503 can have features similar to the first and second flat components 201 and 203 discussed above. The microelectronic device 505 can be used to store, receive, and transmit suitable signals and/or information (e.g., a product identification of a load that is secured by the tie-down/sling apparatus) to an operator or others. Examples of the microelectronic device can include radio-frequency identification (RFID) chips, microelectronic circuits, programmable logic circuits, and/or other suitable devices. By doing so, the tie-down/sling apparatus 500 enables operators to have a quick access to the suitable information. For example, an operator can use an RFID scanner to retrieve product information of a load secured by the tie-down/sling apparatus 500 by scanning the microelectronic device 505 positioned inside the tie-down/sling apparatus 500. In various embodiments, a reflective surface 507 of the second flat component 503 can include other information (e.g., reflective text of “SCAN HERE FOR PRODUCT INFORMATION”) to be visually presented to an operator or others.

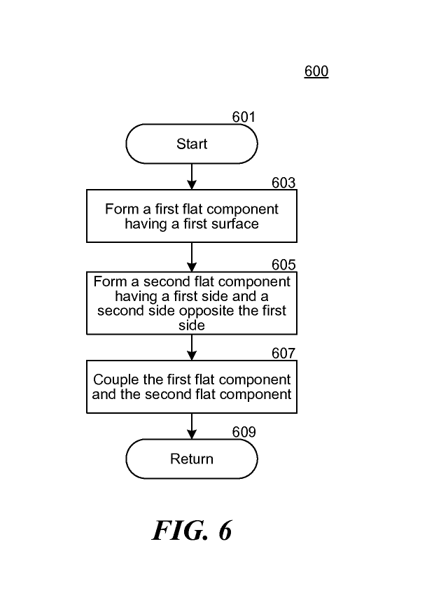

FIG. 6 is a flow chart illustrating a method 600 for manufacturing a tie-down/sling apparatus in accordance with various embodiments of the present technology. The method 600 begins at block 601. At block 603, the method 600 forms a first flat component having a first surface. When an operator operates the first flat component (e.g., using it to secure a load), the first surface is positioned on a visible side (e.g., can be seen by the operator). In various embodiments, the first flat component can have a first thickness ranging from 1 mm to 5 mm. In some embodiments, the first flat component can be coupled to at least one locking component (e.g., a ratchet device, a buckle device, a latch device, and/or the like). In various embodiments, the first flat component can be made of: polyester, polypropylene, cotton, nylon, and/or the like. At block 603, the method 600 continues by conditioning the first surface. In various embodiments, conditioning the first surface can include removing a protection layer (e.g., a plastic film) therefrom, removing impurities attached thereto, and/or removing undesired particles thereon.

At block 605, the method 600 can proceed by forming a second flat component. The second flat component has a first side and a second side opposite the first side. In some embodiments, the second flat component can include an imprint layer. In other embodiments, the second flat component can be made from reflective inks. In various embodiments, the second flat component can have a second thickness ranging from 1 mm to 5 mm. In various embodiments, the second flat component can be made of polyvinyl chloride (PVC), polyurethane (PU) and/or the like. The second side of the second flat component includes a reflective surface configured to visually present suitable information to an operator or others. Examples of the suitable information can include instructions for properly operating the tie-down/sling apparatus, brand names, marketing materials (e.g., an advertisement) and/or the like.

The first side of the second flat component is configured to be in contact with the first surface of the first flat component. At block 607, the method 600 can couple the first flat component and the second flat component by fixedly attaching the first side to the first surface. In various embodiments, the first side and the first surface can be fixedly attached by a heat press process. In some embodiments, an operating temperature of the heat press process can range from 140° C. to 200° C. In some embodiments, an operating duration of the heat press process can be completed within 1 to 3 seconds.

In some embodiments, the second flat component can be pre-made by a molding process (e.g., in a mass production process). In these embodiments, the first side and the first surface can be fixedly attached by suitable adhesives (e.g., glue). In various embodiments, the first side and the first surface can be fixedly attached by a silk screen printing process. In the silk screen printing process, at least a portion of the second flat component can be formed from reflective ink positioned in a reaction tank. For example, the first flat component can be positioned in the reaction tank, and the second flat component can be form on the first surface of the first flat component. The method 600 then returns at block 609.

In various embodiments, the method 600 can further include positioning a microelectronic device between the first flat component and the second flat component. In various embodiments, examples of the microelectronic device include RFID chips, microelectronic circuits, programmable logic circuits, and/or other suitable devices. The microelectronic device can be configured to receive and/or transmit signals or suitable information to an operator or others. For example, the microelectronic device can store product information of a load, instructions for properly operating a tie-down/sling apparatus, and/or other suitable information.

The embodiments described above are meant to exemplify some types of possibilities. In no way should the aforementioned examples limit the scope of the present technology, as they are only exemplary. Various modifications and additions can be made to the embodiments discussed without departing from the scope of the present technology. For example, while the embodiments described above refer to particular features, the scope of this technology also includes embodiments having different combinations of features and embodiments that do not include all of the described features. Accordingly, the scope of the present technology is intended to embrace all such alternatives, modifications, and variations and all equivalents thereof.

From the foregoing, it will be appreciated that specific embodiments of the invention have been described herein for purposes of illustration, but that various modifications may be made without deviating from the scope of the technology. Accordingly, the invention is not limited except as by the appended claims.

1-9. (canceled)

10. An apparatus, comprising:
a first flat component having a first surface, wherein the first surface is conditioned based on a predetermined standard; and
a second flat component having a first side and a second side opposite the first side, the second flat component being positioned on the first flat component by fixedly attaching the first side to the first surface;
wherein the second side includes a reflective surface configured to visually present a set of information.

11. The apparatus of claim 10, further comprising a locking component coupled to the first flat component.

12. The apparatus of claim 10, wherein the first flat component includes a tie-down component with a first thickness ranging from 1 mm to 5 mm, and wherein the second flat component includes an imprint layer with a second thickness ranging from 0.1 mm to 0.5 .mm.

13. The apparatus of claim 10, wherein the first flat component includes at least one of polyester, polypropylene, cotton, and nylon, and wherein the second flat component includes at least one of polyvinyl chloride (PVC) and polyurethane (PU).

14. The apparatus of claim 10, wherein the set of information includes at least one of an instruction for properly operating the tie-down apparatus, a brand name, and a marketing material.

15. The apparatus of claim 10, wherein the first side and the first surface are fixedly attached by a heat press process with an operating temperature ranging from 140° C. to 200° C. and an operating duration ranging from 1 to 3 seconds.

16. The apparatus of claim 10, wherein the first side and the first surface are fixedly attached by a silk screen printing process, and wherein at least a portion of the second flat component is formed by reflective ink.

17. The apparatus of claim 10, wherein the second flat component is pre-made by a molding process, and wherein the first side and the first surface are fixedly attached by an adhesive.

18. The apparatus of claim 10, further comprising a microelectronic device positioned between the first flat component and a second flat component, wherein the set of information is a first set of information, and wherein the microelectronic device is configured to transmit a second set of information.

19-20. (canceled)
